(19) United States
(12) Patent Application Publication
(10) Pub. No.: US 2004/0055811 A1
(43) Pub. Date: Mar. 25, 2004

(54) Earphone device

(76) Inventor: Jack Shih, Taipei Hsien (TW)

Correspondence Address: FULWIDER PATTON LEE & UTECHT, LLP, HOWARD HUGHES CENTER, 6060 CENTER DRIVE, TENTH FLOOR, LOS ANGELES, CA, 90045, US

(21) Appl. No.: 10/247,417

(22) Filed: Sep. 19, 2002

(51) Int. Cl. H04R 25/00

(52) U.S. Cl. 181/129; 181/130; 181/137

(57) ABSTRACT

An earphone device includes a housing, an electrical unit and a speaker. The housing has first and second portions, and an arc-shaped portion with a first end connected to the first portion and a second end connected to the second portion. The first and second portions have confronting inner end surfaces. The arc-shaped portion has a curved inner surface contiguous with the inner end surfaces of the first and second end portions. The curved inner surface cooperates with the inner end surfaces to define a cavity having a size sufficient to permit extension of an upper part of the human outer ear therethrough. The electrical unit has components distributed between the first and second portions. The speaker is mounted on the housing, is coupled to the electrical unit, and is disposed in the cavity so as to be located adjacent to an ear canal of the human outer ear.

### BACKGROUND OF THE INVENTION

1. Field of the Invention

This invention relates to an earphone device, more particularly to a wireless earphone device, which is comfortable to wear and which can be secured in place during use.

2. Description of the Related Art

Following recent developments and widespread application in wireless communications technology, the wireless earphone has become one of the most popular audio/video electronic products.

Referring to FIG. 1, a conventional wireless earphone 91 is shown to include an ear-hook main body 911 provided with a plurality of electronic elements (not shown) to achieve functions, such as wireless transmission, audio signal processing, and the like. A speaker 913 is mounted on a distal end of a speaker arm 912 for the output of sounds, and a microphone 915 is mounted on the distal end of a microphone arm 914 for the pick-up of audio signals from the user.

In use, the weight center of the earphone 91 will be located rearwardly of the human outer ear 92, as best shown in FIG. 1. Therefore, movement of the user's head can cause the earphone 91 to become unstable and unbalanced, whereby the earphone 91 tends to move or even fall off from the user's ear and can apply uncomfortable pressure to the user's ear. Moreover, the conventional earphone 91 is designed only for use with the right or left ear of the user.

### SUMMARY OF THE INVENTION

The object of the present invention is to provide an earphone device that is free of the aforesaid drawbacks of the prior art.

According to this invention, an earphone device includes a housing, an electrical unit and a speaker. The housing includes a first portion, a second portion, and an arc-shaped portion with a first end connected to the first portion and a second end connected to the second portion. The first and second portions have confronting inner end surfaces. The arc-shaped portion has a curved inner surface contiguous with the inner end surfaces of the first and second end portions. The curved inner surface cooperates with the inner end surfaces to define a cavity having a size sufficient to permit extension of an upper part of the human outer ear therethrough when the curved inner surface is disposed on an upper part of an incurved rim that appends the human outer ear to the human head.

The electrical unit is disposed in the housing and has components distributed between the first and second portions. The components include a control circuit and a power supply coupled electrically to the control circuit.

The speaker is mounted on the housing and is coupled electrically to the control circuit. The speaker is disposed in the cavity so as to be located adjacent to an ear canal of the human outer ear when the curved inner surface of the arc-shaped portion is disposed on the upper part of the incurved rim that appends the human outer ear to the human head. Preferably, the speaker is rotatable relative to the housing to adapt the earphone device for use with the left or right ear of the user.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a schematic view illustrating a conventional wireless earphone in a state of use;

FIG. 2 is an exploded perspective view illustrating the preferred embodiment of the present invention;

FIG. 3 is a schematic view illustrating how the components of the electrical unit are distributed in the preferred embodiment of the present invention;

FIG. 4 is another schematic view showing the distribution of the components of the electrical unit shown in FIG. 3;

FIG. 5 is a schematic view similar to FIG. 3 but showing a curved leg member of the preferred embodiment when extended out of a curved channel;

FIG. 6 is a schematic side view of the preferred embodiment;

FIG. 7 is a schematic view illustrating the preferred embodiment of the present invention in a state of use; and

FIG. 8 is a schematic side view of another preferred embodiment according to the present invention.

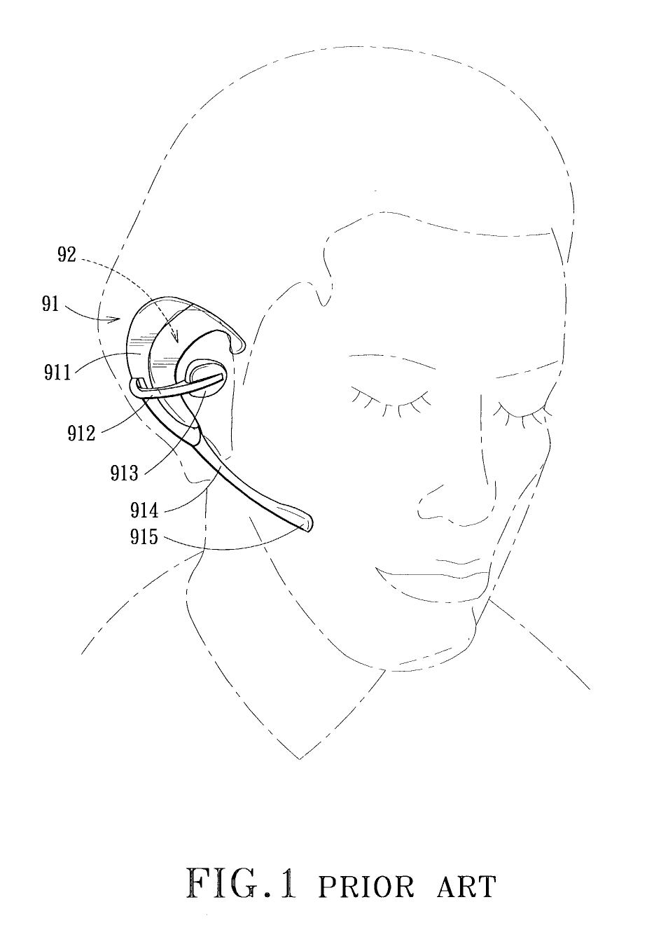

### DETAILED DESCRIPTION OF THE PREFERRED EMBODIMENTS

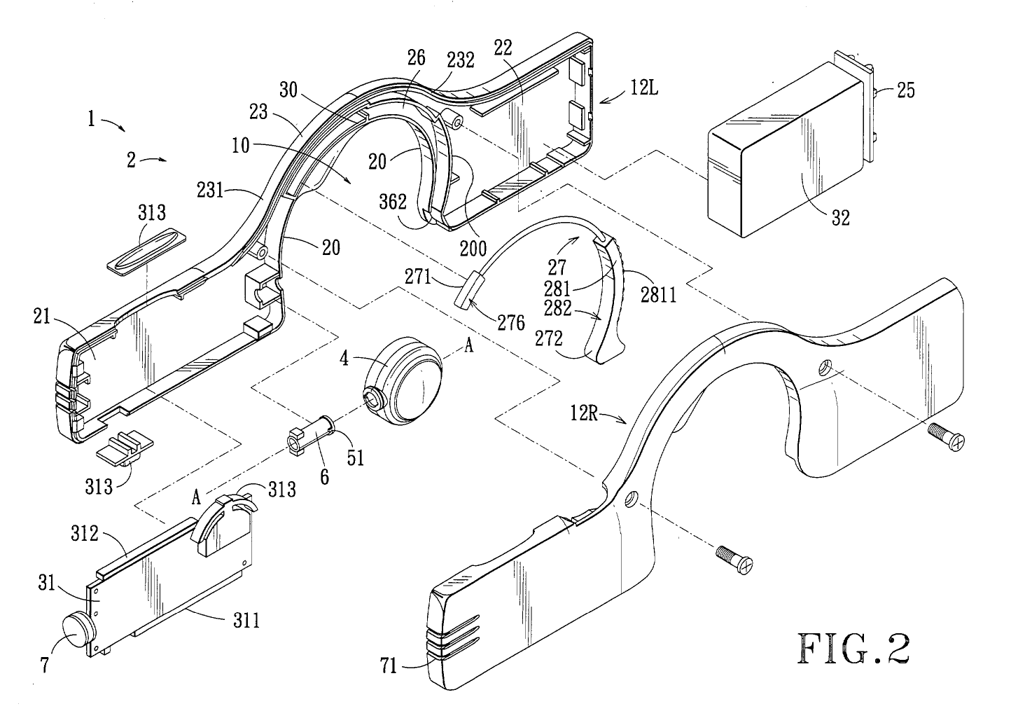

Referring to FIG. 2, the first preferred embodiment of the earphone device 1, which is an audio accessory, according to the present invention is shown to comprise a housing 2, an electrical unit 3 and a speaker 4, which is a transducer.

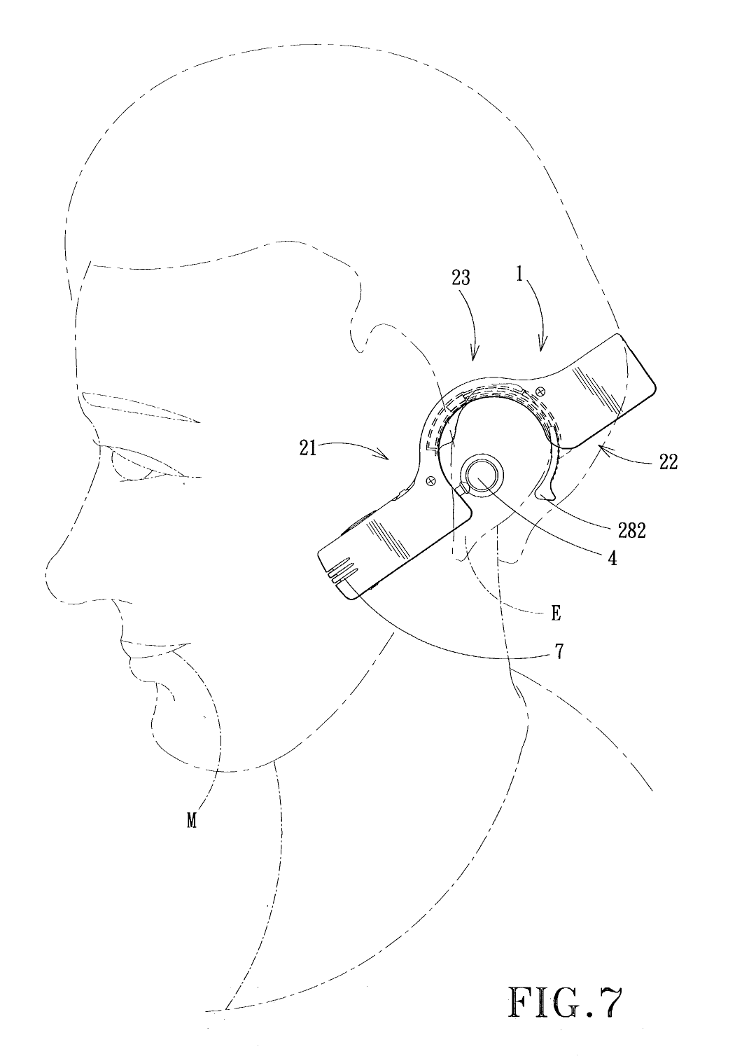

The housing 2 of the earphone device 1 includes a rectangular first portion 21, a rectangular second portion 22, and an arc-shaped portion 23 with a first end 231 connected to the first portion 21 and a second end 232 connected to the second portion 22. The first and second portions 21, 22 have confronting inner end surfaces 20. The arc-shaped portion 23 has a curved inner surface 30 contiguous with the inner end surfaces 20 of the first and second end portions 21, 22. The curved inner surface 30 cooperates with the inner end surfaces 20 to define a cavity 10 having a size sufficient to permit extension of an upper part of the human outer ear (E) (see FIG. 7) therethrough when the curved inner surface 30 is disposed on an upper part of an incurved rim that appends the human outer ear (E) to the human head. Preferably, the housing 2 includes complementary housing halves (12R, 12L) that configure the housing 2 with the first, second and arc-shaped portions 21, 22, 23. Referring further to FIG. 7, the first portion 21 inclines downwardly and forwardly and the second portion 22 inclines upwardly and rearwardly relative to the human outer ear (E) when the curved inner surface 30 of the arc-shaped portion 23 is disposed on the upper part of the incurved rim that appends the human outer ear (E) to the human head.

The electrical unit 3 of the earphone device 1 is disposed in the housing 2 and has components distributed between the first and second portions 21, 22. The components include a control circuit 31 and a power supply 32 coupled electrically to the control circuit 31. Preferably, the components of the electrical unit 3 are distributed such that the first and second portions 21, 22 have substantially balanced loads relative to the arc-shaped portion 23.

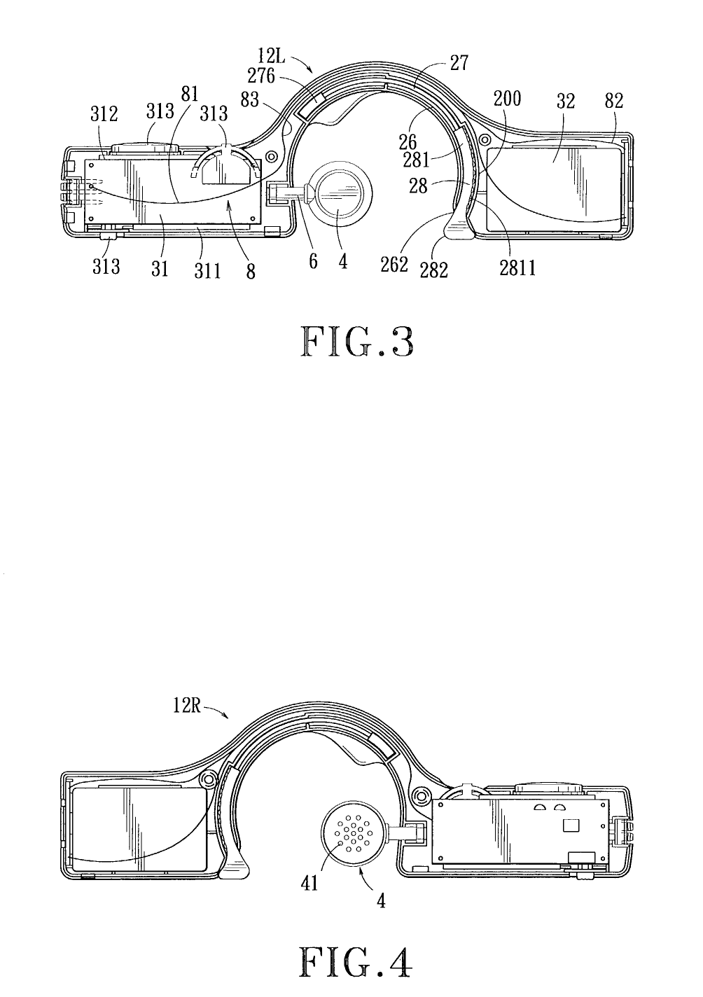

Referring further to FIGS. 3, the first and second portions 21, 22 are substantially symmetrical in shape with respect to the arc-shaped portion 23. Preferably, the control circuit 31 is accommodated in the first portion 21, and the power supply 32 is accommodated in the second portion 22. Preferably, the control circuit 31 includes at least one control button 313 for volume control, microphone/speaker switching and power switching, which is mounted on the first portion 21 and which is accessible externally of the first portion 21. Preferably, the power supply 32 is a rechargeable battery, and the second portion 22 is provided with a set of charging contacts 25 coupled electrically to the power supply 32 to permit recharging of the power supply 32.

The speaker 4 is mounted on the housing 2 and is coupled electrically to the control circuit 31. The speaker 4 is disposed in the cavity 10 so as to be located adjacent to an ear canal of the human outer ear (E) when the curved inner surface 30 of the arc-shaped portion 23 is disposed on the upper part of the incurved rim that appends the human outer ear (E) to the human head, as best shown in FIG. 7. Preferably, the speaker 4 is formed with a plurality of sound transmission holes 41 (see FIG. 4) and is mounted rotatably on the inner end surface 20 of the first portion 21, such that the earphone device 1 can be adapted for use with either the right or left ear. In this embodiment, the earphone device 1 further includes a limit unit 51, in the form of the stop blocks, provided on the speaker 4 and the first portion 21 to limit angular rotation of the speaker 4, such as within a 180-degree range.

Referring to FIG. 2, the earphone device 1 further includes a shaft 6 mounted on the housing 2 and extending into the cavity 10. The speaker 4 is mounted rotatably on the shaft 6 and is rotatable relative to an axis (A) of the shaft 6. In this embodiment, the limit unit 51 is provided on the shaft 6 and the speaker 4 to limit rotation of the speaker 4 about the axis (A), thereby preventing damage to electrical wires (not shown) inside the shaft 6 that connect the speaker 4 to the control circuit 31.

In this embodiment, the earphone device 1 further includes a microphone 7 coupled electrically to the control circuit 31 and mounted in the first portion 21 of the housing 2 adjacent to a plurality of sound receiving holes 71. The microphone 7 is disposed adjacent to a mouth (M) on the human head when the curved inner surface 30 of the arc-shaped portion 23 is disposed on the upper part of the incurved rim that appends the human outer ear (E) to the human head, as best shown in FIG. 7. Preferably, the control circuit 31 is a known circuit capable of wireless transmission and reception of electrical signals. Preferably, the control circuit 31 includes first and second antennas 311, 312 for transmission and reception of electrical signals, thereby permitting wireless connection to an electronic device, such as a mobile phone or audio equipment.

Referring to FIGS. 3 to 5, the earphone device 1 further includes a conductor 8 disposed in the housing 2 and having a first connecting section 81 coupled to the control circuit 31 and extending between the first and second antennas 311, 312, a second connecting section 82 coupled to the power supply 32, and an intermediate section 83 interconnecting the first and second connecting sections 81, 82 and extending through the arc-shaped portion 23. The arrangement as such can reduce electromagnetic interference to the antennas 311, 312 by the conductor 8.

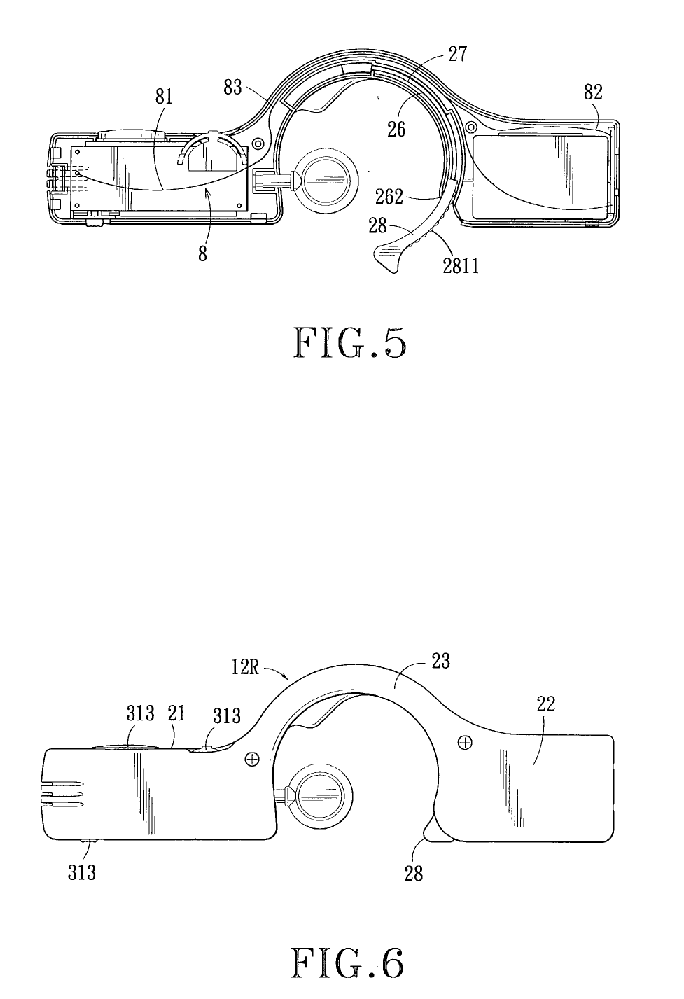

Referring to FIGS. 2, 3, 5 and 6, in this embodiment, the housing 2 of the earphone device 1 is formed with a curved channel 26 that extends along the arc-shaped portion 23 and that extends through the second portion 22 to conform to the contour of the periphery of the user's outer ear. The earphone device 1 further comprises a curved leg member 27 slidably disposed in the channel 26 and movable in and out of the channel 26 for contacting a skin part of the human head behind the human outer ear (E), as best shown in FIG. 7. Preferably, the leg member 27 is made of an elastic metal wire. The channel 26 includes an opening 262 formed in the second portion 22. The leg member 27 has inner and outer ends 271, 272 respectively disposed distal from and proximate to the opening 262 of the channel 26. The inner end 271 is provided with a rubber stop block 276 having a size larger than the opening 262 to prevent removal of the leg member 27 from the channel 26. In this embodiment, the earphone device 1 further includes a rubber contact block 28 having a sleeve portion 281 sleeved on the outer end 272 of the leg member 27, and a contact portion 282 connected to the sleeve portion 281 and disposed outwardly of the channel 26. The contact portion 282 has a size larger than the opening 262 to prevent the contact block 28 from extending fully into the channel 26. Preferably, the housing 2 of the earphone device 1 is formed with a channel-confining wall 200 that confines the channel 26. The sleeve portion 281 is formed with a plurality of friction ribs 2811 for friction engagement with the channel-confining wall 200 to permit positioning of the leg member 27 at a desired extended position relative to the channel 26. Therefore, the curved leg member 7 can be extended fully out of the curved channel 26 (see FIG. 5) or adjusted to a desired extended position (see FIG. 7), thereby enhancing stability of the earphone device 1 when worn.

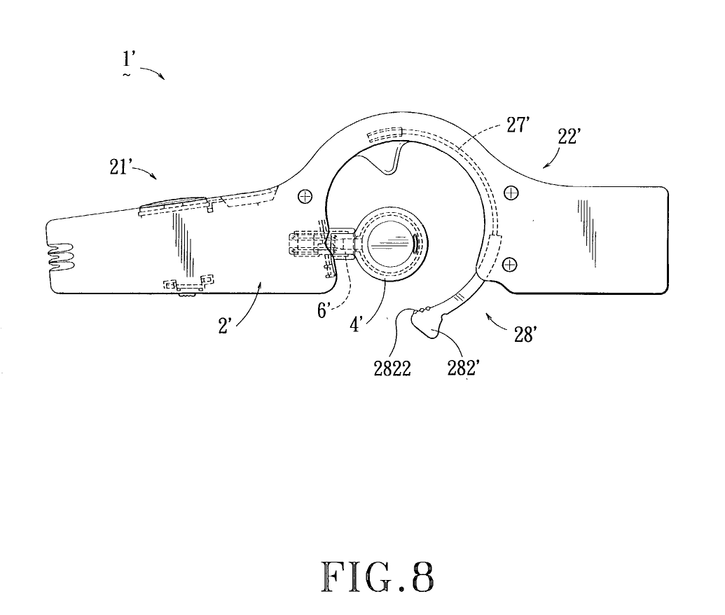

Referring to FIG. 8, in the second embodiment of the earphone device 1′ of this invention, the first portion 21′ is longer than the second portion 22′ for aesthetic purposes. Moreover, the shaft 6′ is connected to the speaker 4′ and is mounted rotatably on the housing 2′. The limit unit (not visible) is provided on the shaft 6′ and the housing 2′ for limiting axial rotation of the shaft 6′. Furthermore, the contact portion 282′ of the contact block 28′ is formed with a plurality of ridges 2822 to facilitate handling of the contact block 28′ when moving the leg member 27′ in and out of the channel 26′.

Therefore, by virtue of the substantially balanced loads of the first and second portions 21, 22, the earphone device 1 of this invention can be stably secured on an upper part of the incurved rim that appends the human outer ear (E) to the human head. Adjustment of the inclination of the housing 2 will allow the earphone device 1 of this invention to be set at the most stable and comfortable position. Further, since the load of the earphone device 1 is well balanced on the user's ear, comfort can be enhanced for long-term wearing. Moreover, in addition to its light weight and small size for easy wearing, carrying and storage, the earphone device 1 of this invention can be used with either the right or left ear.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

I claim:

1. An earphone device adapted for a human outer ear, comprising:
a housing having a first portion, a second portion, and an arc-shaped portion with a first end connected to said first portion and a second end connected to said second portion, said first and second portions having confronting inner end surfaces, said arc-shaped portion having a curved inner surface contiguous with said inner end surfaces of said first and second end portions, said curved inner surface cooperating with said inner end surfaces to define a cavity having a size sufficient to permit extension of an upper part of the human outer ear therethrough when said curved inner surface is disposed on an upper part of an incurved rim that appends the human outer ear to the human head;
an electrical unit disposed in said housing and having components distributed between said first and second portions, said components including a control circuit and a power supply coupled electrically to said control circuit; and
a speaker mounted on said housing and coupled electrically to said control circuit, said speaker being disposed in said cavity so as to be located adjacent to an ear canal of the human outer ear when said curved inner surface of said arc-shaped portion is disposed on the upper part of the incurved rim that appends the human outer ear to the human head.

2. The earphone device as claimed in claim 1, wherein said components of said electrical unit are distributed such that said first and second portions have substantially balanced loads relative to said arc-shaped portion.

3. The earphone device as claimed in claim 1, wherein said first and second portions are substantially symmetrical in shape with respect to said arc-shaped portion.

4. The earphone device as claimed in claim 1, wherein said control circuit is accommodated in said first portion, and said power supply is accommodated in said second portion.

5. The earphone device as claimed in claim 4, wherein said speaker is mounted rotatably on said inner end surface of said first portion.

6. The earphone device as claimed in claim 5, further comprising a limit unit provided on said speaker and said first portion to limit angular rotation of said speaker.

7. The earphone device as claimed in claim 1, further comprising a shaft mounted on said housing and extending into said cavity, said speaker being mounted rotatably on said shaft and being rotatable relative to an axis of said shaft.

8. The earphone device as claimed in claim 7, further comprising a limit unit provided on said shaft and said speaker for limiting angular rotation of said speaker.

9. The earphone device as claimed in claim 1, further comprising a shaft connected to said speaker and mounted rotatably on said housing.

10. The earphone device as claimed in claim 9, further comprising a limit unit provided on said shaft and said housing for limiting axial rotation of said shaft.

11. The earphone device as claimed in claim 4, wherein said power supply is a rechargeable battery, and said second portion is provided with a set of charging contacts coupled electrically to said power supply to permit recharging of said power supply.

12. The earphone device as claimed in claim 1, further comprising a microphone coupled electrically to said control circuit and mounted in said housing.

13. The earphone device as claimed in claim 4, wherein said first portion inclines downwardly and forwardly and said second portion inclines upwardly and rearwardly relative to the human outer ear when said curved inner surface of said arc-shaped portion is disposed on the upper part of the incurved rim that appends the human outer ear to the human head.

14. The earphone device as claimed in claim 13, further comprising a microphone coupled electrically to said control circuit and mounted in said first portion such that said microphone is disposed adjacent to a mouth on the human head when said curved inner surface of said arc-shaped portion is disposed on the upper part of the incurved rim that appends the human outer ear to the human head.

15. The earphone device as claimed in claim 1, wherein said housing is formed with a curved channel that extends along said arc-shaped portion and that extends through said second portion, said earphone device further comprising a curved leg member slidably disposed in said channel and movable in and out of said channel for contacting a skin part of the human head behind the human outer ear.

16. The earphone device as claimed in claim 15, wherein said channel includes an opening formed in said second portion, said leg member having inner and outer ends respectively disposed distal from and proximate to said opening of said channel, said inner end being provided with a stop block having a size larger than said opening to prevent removal of said leg member from said channel.

17. The earphone device as claimed in claim 15, wherein said channel includes an opening formed in said second portion, said leg member having inner and outer ends respectively disposed distal from and proximate to said opening of said channel, said earphone device further comprising a contact block having a sleeve portion sleeved on said outer end of said leg member, and a contact portion connected to said sleeve portion and disposed outwardly of said channel, said contact portion having a size larger than said opening to prevent said contact block from extending fully into said channel.

18. The earphone device as claimed in claim 17, wherein said housing is formed with a channel-confining wall that confines said channel, said sleeve portion being formed with a plurality of friction ribs for friction engagement with said channel-confining wall to permit positioning of said leg member at a desired extended position relative to said channel.

19. The earphone device as claimed in claim 17, wherein said contact portion is formed with a plurality of ridges to facilitate handling of said contact block when moving said leg member in and out of said channel.

20. An audio accessory adapted for a human outer ear, comprising:
a housing having a first portion, a second portion, and an arc-shaped portion with a first end connected to said first portion and a second end connected to said second portion, said first and second portions having confronting inner end surfaces, said arc-shaped portion having a curved inner surface contiguous with said inner end surfaces of said first and second end portions, said curved inner surface cooperating with said inner end surfaces to define a cavity having a size sufficient to permit extension of an upper part of the human outer ear therethrough when said curved inner surface is disposed on an upper part of an incurved rim that appends the human outer ear to the human head;
an electrical unit disposed in said housing and having components distributed between said first and second portions, said components including a control circuit and a power supply coupled electrically to said control circuit; and
a transducer mounted on said housing and coupled electrically to said control circuit.
